(19) United States
(12) Patent Application Publication
(10) Pub. No.: US 2007/0181098 A1
(43) Pub. Date: Aug. 9, 2007

(54) INTERNAL COMBUSTION ENGINE WITH THREE VALVES PER CYLINDER

(76) Inventor: Bruno De Prato, Dresano (Milano) (IT)

Correspondence Address: PATTERSON & SHERIDAN, L.L.P., 3040 POST OAK BOULEVARD, SUITE 1500, HOUSTON, TX, 77056, US

(21) Appl. No.: 11/671,975

(22) Filed: Feb. 6, 2007

(30) Foreign Application Priority Data
Feb. 7, 2006 (IT) TO2006A000081

(51) Int. Cl. F02B 75/02; F02F 3/26

(52) U.S. Cl. 123/315; 123/279

(57) ABSTRACT

Otto cycle internal combustion engine, comprising a cylinder block including at least one cylinder having a longitudinal axis, a piston movable within said cylinder and having a recess open on a head surface of the piston, a head fastened to said cylinder block and having a surface facing said cylinder, a plurality of valves movable along respective rectilinear directions and co-operating with respective valve seats situated in said head, and a combustion chamber delimited at one side by a portion of the surface of the head facing the cylinder and, at the other side, by the surface of said recess of the piston. The engine comprises a single intake valve and two exhaust valves. The intake valve has significantly larger diameter than that of the two exhaust valves.

### CROSS-REFERENCE TO RELATED APPLICATIONS

This application claims benefit of Italian patent application number TO2006A000081, filed Feb. 7, 2006, which is herein incorporated by reference.

### BACKGROUND OF THE INVENTION

### Field of the Invention

The present invention relates to an Otto cycle internal combustion engine with three valves per cylinder. The present invention relates in particular to a combustion chamber configuration and the related distribution architecture associated thereto.

### SUMMARY OF THE INVENTION

The present invention has the object of providing an internal combustion engine with high thermodynamic efficiency provided, at the same time, with good volumetric efficiency up to high rpm rates.

According to the present invention, said object is achieved by an engine having the characteristics set out in the claims.

In the solution according to the present invention, a single intake valve and two exhaust valves are provided, with the intake valve having a significantly greater diameter than that of the two exhaust valves. The combustion chamber is formed exclusively in the piston and it preferably has the shape of a recess that has either hemispherical or sphere portion shape, whose axis is slightly offset relative to the longitudinal axis of the cylinder.

The combination of the intake valve with large diameter and the partially offset combustion chamber positioned underlying it enables to obtain good volumetric efficiency up to rpm rates around 8000 rpm and high thermodynamic efficiency.

Moreover, this distribution arrangement leaves available the central area of the head for a correct positioning of the spark plug, even if single-shaft timing is used.

The timing arrangement according to the present invention enables, at equal bore values, to use an intake valve with significantly greater diameter than the largest one possible in the presence of a single properly dimensioned exhaust valve. A significant increase in the volumetric efficiency of the engine is thereby obtained, even in the presence of limited lifts and phase crossovers. The adoption of two exhaust valves with significantly smaller diameter than that of a single exhaust valve with equal flow efficiency entails a better management of the heat loads involving the head, by virtue of the faster rate whereat the two small-diameter valves cool off, compared to a single, large-diameter valve. From this derives a reduction in the residual temperature present in the combustion chamber at the time of the entry of the cool load of air-fuel mixture. In this way, the threshold of activation of possible self-ignition phenomena is further raised and it is consequently possible to adopt higher compression ratios than those currently found on series-built engines, with significant advantage in terms of thermodynamic efficiency.

The hemispherical configuration of the combustion chamber obtained in the piston contributes to accentuate this advantage.

### BRIEF DESCRIPTION OF THE DRAWINGS

Additional characteristics and advantages of the present invention shall become readily apparent in the detailed description that follows, provided purely by way of non limiting example, with reference to the accompanying drawings, in which:

FIG. 1 is a schematic view of an engine according to the present invention,

FIG. 2 is a section according to the line II-II of FIG. 1, and

FIG. 3 is a section according to the line III-III of FIG. 1.

### DETAILED DESCRIPTION

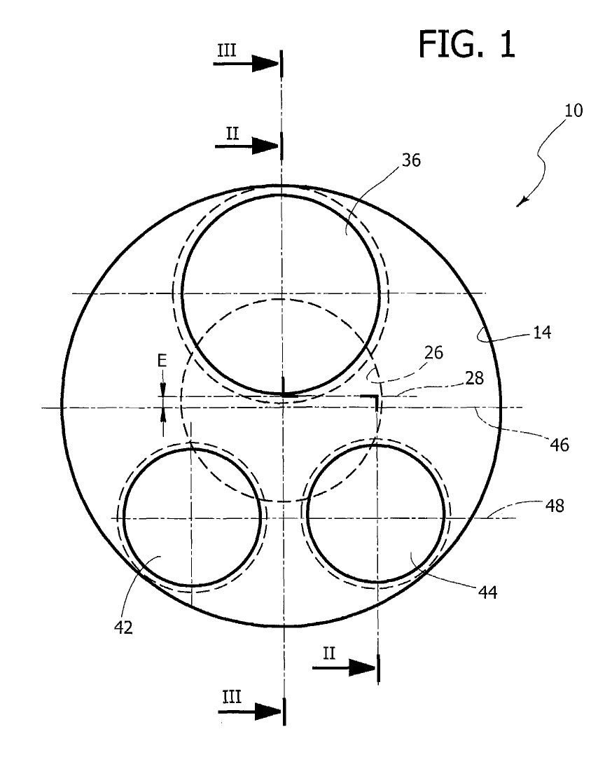

In FIGS. 1 through 3, the numeral 10 designates a portion of an Otto cycle internal combustion engine according to the present invention. The invention is described with reference to a single cylinder of an engine. However, the invention can be applied both to single-cylinder engine and to multi-cylinder engines with various configurations (in line, boxer, V, etc.).

The present invention relates principally to the configuration of the combustion chamber and the related timing architecture. Consequently, only the upper part of the engine 10 is illustrated herein. The components of the engine that are not illustrated herein can be considered to be of a conventional type.

The engine 10 comprises a cylinder block 12 in which is formed at least one cylinder 14 having a longitudinal axis 16.

In the cylinder 14 is alternatively movable a piston 18 that is articulated in conventional fashion to a connecting rod 20 by means of a piston pin 22. The piston 18 has a head surface 24 that is planar and orthogonal to the longitudinal axis 16 of the cylinder 14.

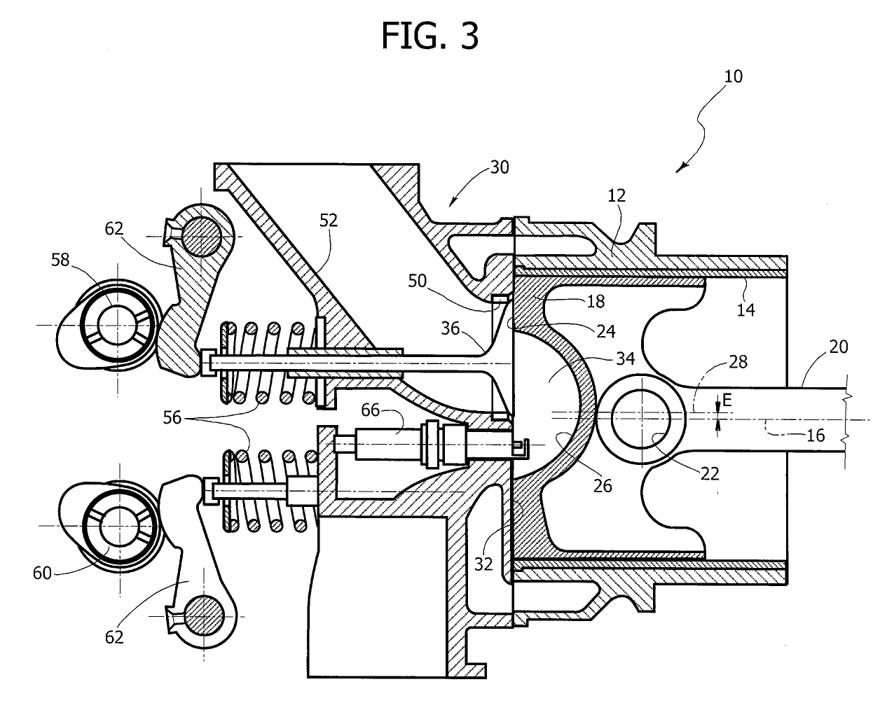

In the piston 18 is formed a recess 26 open on the head surface 24 and having a hemispherical configuration or a sphere portion configuration. The longitudinal axis of symmetry of the recess 26, designated by the numeral 28 in FIG. 3, is in eccentric position relative to the longitudinal axis 16 of the cylinder 14. The eccentricity between the axes 16 and 28 is designated by the reference E in FIGS. 1 and 3.

The engine 10 comprises a head 30 fastened to the cylinder block 12. The head 30 has a surface 32 facing the cylinder 14. Preferably, the surface 32 is planar and orthogonal to the longitudinal axis 16.

When the piston 18 is in its top dead centre position, the head surface 24 of the piston 18 is almost in contact with the planar surface 32 of the head 30. The portion of the surface 32 facing the recess 26 and the recess surface 26 define, in the top dead centre position of the piston 18, a combustion chamber 34.

The volume of the combustion chamber 34 is substantially equal to the volume of the recess 26 formed in the piston 18, so it can briefly be said that the combustion chamber 34 is obtained exclusively in the piston 18. In FIG. 3, the numeral 66 designates a spark plug whose electrodes conventionally project into the combustion chamber 34.

With reference to FIG. 1, the head 30 is provided with a single intake valve 36 and with two exhaust valves 42, 44. The intake valve 36 and the exhaust valves 42, 44 are positioned at opposite sides relative to a plane containing the longitudinal axis 16, designated by the numeral 46 in FIG. 1. The two exhaust valves 42, 44 have the same diameter and they have their centres aligned on an axis 48 parallel to the plane 46. The two exhaust valves 42, 44 are positioned at opposite sides relative to a plane containing the longitudinal axis 16 and orthogonal relative to the plane 46. The centre of the intake valve 36 is contained in the plane that passes through the longitudinal axis 16 and orthogonal to the plane 46.

The intake valve 36 has a significantly larger diameter than the diameter of the two exhaust valves 42, 44. In the example shown in FIG. 1, the diameter of the intake valve 36 is slightly smaller than half the bore of the cylinder 14.

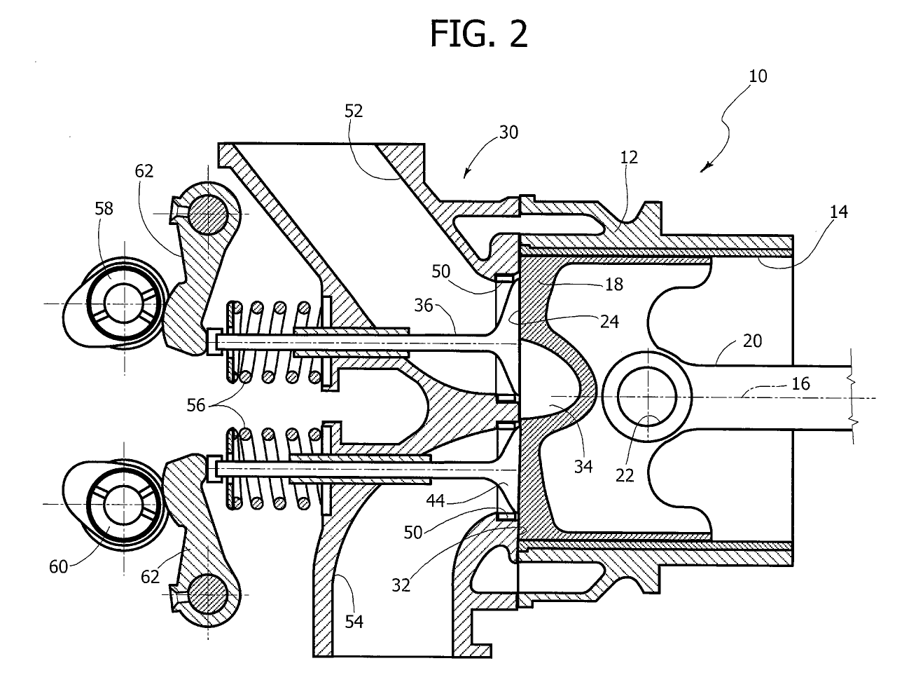

With reference to FIGS. 2 and 3, the intake and exhaust valves 36, 42, 44 are conventional mushroom valves, each of which co-operates with a respective valve seat 36, inserted or integral. Each valve is associated to a respective intake conduit 52 or exhaust conduit 54.

Conventionally, each valve is associated to elastic elements 56 which tend to maintain the valve in closed position. The opening of the valves is actuated by two camshafts 58, 60. The camshaft 58 actuates the opening of the intake valve 36 and the camshaft 60 actuates the opening of the two exhaust valves 42, 44. In the illustrated embodiment, each valve is associated to a respective intermediate actuating member 62 articulated to the head around an axis parallel to the axes of the camshafts 58, 60. Each intermediate actuating member 62 is interposed between one end of a valve and a respective cam formation 64 of the respective camshaft 58, 60.

The valves 36, 42, 44, are all movable along respective rectilinear directions that are parallel to each other and parallel to the longitudinal axis 16 of the cylinder 14. This characteristic allows to maintain perfectly planar the surface 32 of the head 30 facing the cylinder 14 and, consequently, it allows to obtain the combustion chamber 34 exclusively in the crown of the piston 18.

As stated previously, the combustion chamber 34 is obtained in the crown of the piston 18 and in slightly offset position towards the side of the head 30 where the intake valve 36 is obtained. The offsetting of the combustion chamber has the dual purpose of:

reducing the incidence of the depression at the median axis of the piston (and hence of the piston pin) in order to place the piston pin in as high a position as possible;

reducing the incidence of the area of the niche of the intake valve 36 relative to the squish area obtained around the combustion chamber, in order to minimise improper or incomplete combustion phenomena, which would degrade the thermodynamic efficiency of this combustion chamber configuration.

The small dimensions of the combustion chamber 34, independent of the bore of the cylinder 14, enable to adopt strongly oversquare bore/stroke ratios, without losing anything in terms of cleanliness and compactness of the combustion chamber.

For the containment of polluting emissions, most last-generation Otto cycle engines currently in production have the bore smaller than the stroke (undersquare ratio) with consequent not marginal loss of mechanical efficiency. In order to contain the vertical development of the engines, the tendency is to adopt connecting rod whose distance between the centre of the small end and the centre of the big end, is far lower than twice the value of the stroke, a condition that generates a significant increase in internal friction.

The solution according to the present invention enables significantly to increase the efficiency of the engine, associating a good volumetric efficiency to high thermodynamic and mechanical efficiencies, with the prospective of obtaining specific powers around 100 HP/litre, with lower specific consumption and polluting emissions (HC, CO e CO₂) than those of the best current engines.

Naturally, without altering the principle of the invention, the construction details and the embodiments may be widely varied from what is described and illustrated herein, without thereby departing from the scope of the present invention, as defined by the appended claims.

1. Otto cycle internal combustion engine, comprising:
a cylinder block including at least one cylinder having a longitudinal axis,
a piston movable within said cylinder and having a recess open on a head surface of the piston,
a head fastened to said cylinder block and having a surface facing said cylinder,
a plurality of valves movable along respective rectilinear directions and co-operating with respective valve seats situated in said head, and
a combustion chamber delimited at one side by a portion of the surface of the head facing the cylinder and, at the other side, by the surface of said recess of the piston,
wherein it comprises a single intake valve and two exhaust valves, the intake valve having significantly larger diameter than that of the two exhaust valves.

2. Engine as claimed in claim 1, wherein the valves move along respective rectilinear directions, parallel to each other and parallel to the longitudinal axis of the cylinder.

3. Engine as claimed in claim 1, wherein the recess of the piston has hemispherical or sphere portion shape.

4. Engine as claimed in claim 3, wherein the longitudinal axis of symmetry of the recess is offset relative to the longitudinal axis of the cylinder towards the side of the head in which the intake valve is housed.
